(19) United States
(12) Patent Application Publication
(10) Pub. No.: US 2008/0074706 A1
(43) Pub. Date: Mar. 27, 2008

(54) Image Forming Apparatus and Computer Program Product

(75) Inventors: Hideo Ueno, Nagoya-shi (JP); Masashi Suzuki, Nagoya-shi (JP); Hiroshi Koie, Nagoya-shi (JP); Kazunari Taki, Nagoya-shi (JP); Takahiro Ikeno, Seto-shi (JP); Takahiro Hosokawa, Nagoya-shi (JP)

Correspondence Address: BANNER & WITCOFF, LTD.;ATTORNEYS FOR CLIENT NOS. 0166889, 006760, 1100 13th STREET, N.W., SUITE 1200, WASHINGTON, DC, 20005-4051, US

(73) Assignee: BROTHER KOGYO KABUSHIKI KAISHA, Nagoya-shi, Aichi-ken (JP)

(21) Appl. No.: 11/858,456

(22) Filed: Sep. 20, 2007

(30) Foreign Application Priority Data
Sep. 27, 2006 (JP) 2006-262750

(51) Int. Cl. H04N 1/00

(52) U.S. Cl. 358/403

(57) ABSTRACT

An image forming apparatus includes: an image forming unit; a data recording unit that records a file on a non-contact tag attached to a recording medium; and a controller that controls the image forming unit to form, on the recording medium, an image indicating a storage location of the file recorded on the non-contact tag at a source of the file.

### CROSS-REFERENCE TO RELATED APPLICATION

This application claims priority from Japanese Patent Application No. 2006-262750, filed on Sep. 27, 2006, the entire subject matter of which is incorporated herein by reference.

### TECHNICAL FIELD

Aspects of the present invention relate to an image forming apparatuses including an image forming unit that forms images on a recording medium a data recording unit that records data (file) to anon-contact tag attached to the recording medium, and to a computer program product therefor.

### BACKGROUND

A non-contact tag such as a Radio Frequency Identification tag (RFID tag) is attached to (or embedded in) a recording medium such as a sheet. An image is formed on such recording medium and at the same time, data is recorded on the non-contact tag. For example, JP-A-2005-197834 describes that when an image based on image data is formed on a sheet, the image data is recorded on a non-contact tag attached to the sheet in order to make the original image data available for use in a subsequent copying.

### SUMMARY

A non-contact tag having a large capacity can store thereon various types of data (file) other than the image data. Conventionally, such a situation was not taken into account. Thus, when the non-contact tag has recorded data other than the image data, there was no way of directly knowing what data is recorded on the non-contact tag (e.g., where the recorded data was located at its source). As a matter of course, it is possible to know a storage location where the data (file) was located by reading data from the non-contact tag by a personal computer through a tag reader and analyzing a filename of the data by the personal computer. However, this processing is very complicated.

Aspects of the present invention relate to the above problem. According to at least one aspect of the present invention, a image forming apparatus may be provided that can form an image on a recording medium as well as record data on a non-contact tag attached to the recording medium, so that the storage location of the file at its source, the file being recorded on the non-contact tag, is readily recognized.

According to an aspect of the present invention, an image forming apparatus includes: an image forming unit; a data recording unit that records a file on a non-contact tag attached to a recording medium; and a controller that controls the image forming unit to form, on the recording medium, an image indicating a storage location of the file recorded on the non-contact tag at a source of the file.

### BRIEF DESCRIPTION OF THE DRAWINGS

In the accompanying drawings:

FIG. 1 is a block diagram illustrating the configuration of an image forming apparatus according to an embodiment of the present invention;

FIG. 2 is a schematic cross-sectional view illustrating the internal configuration of a printer as the image forming apparatus;

FIG. 3 is an explanatory view illustrating an example of the configuration of a sheet equipped with a non-contact tag;

FIG. 4 is a flowchart showing a printing control process to be executed in a personal computer communicating with the image forming apparatus;

FIG. 5 is an explanatory view illustrating an example of a file structure image generated in the printing control process;

FIG. 6 is an explanatory view illustrating an example of the file structure image being highlighted;

FIG. 7 is an explanatory view illustrating another example of the file structure image being highlighted;

FIG. 8 is a flowchart showing a printer printing process to be executed by the printer;

FIG. 9 is a flowchart showing a tag data read process to be executed by the printer;

FIG. 10 is an explanatory view illustrating a modified example of the file structure image;

FIG. 11 is an explanatory view illustrating another modified example of the file structure image;

FIGS. 12A and 12B are explanatory views illustrating another modified examples of the file structure image; and

FIG. 13 is an explanatory view illustrating still another modified example of the file structure image.

### DETAILED DESCRIPTION

### Overall Configuration of the Embodiment

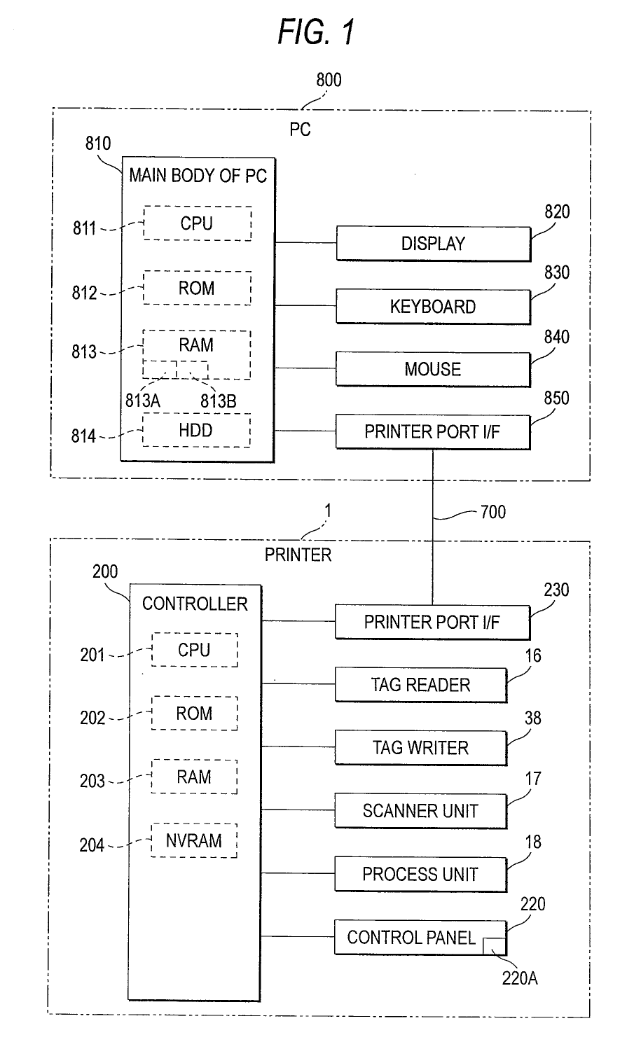

Next, embodiments of the present invention will be described below with reference to the accompanying drawings. FIG. 1 is a block diagram showing the configuration of an image forming apparatus according to an embodiment of the present invention. As shown in FIG. 1, the image forming apparatus of this embodiment includes a printer 1 serving as a main image forming apparatus and a personal computer (hereinafter simply referred to as PC) 800 serving as a host connected to the printer 1 via a cable 700. Note that the printer 1 and the PC 800 may be connected with each other through a network such as an intranet LAN or the Internet.

[Description of the Configuration of the Printer 1]

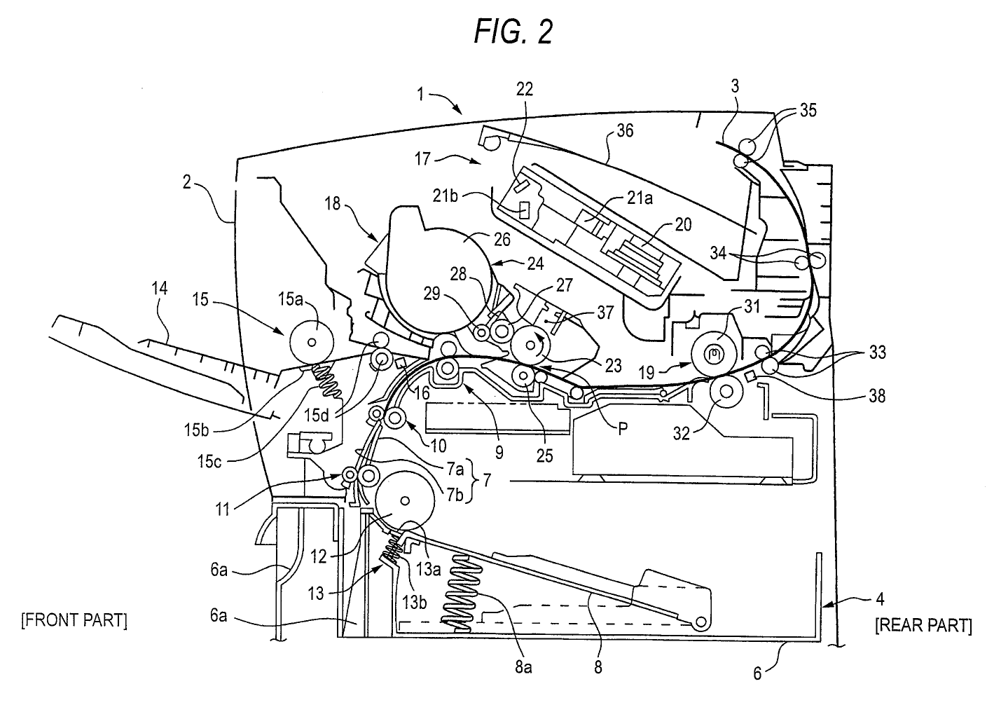

FIG. 2 is a schematic cross-sectional view showing the internal configuration of the printer 1. As shown in FIG. 2, within a main body case 2, the printer 1 includes a feeder part 4 for feeding sheet 3 serving as a recording medium; a multi-purpose tray 14; a process unit 18 as an example of an image forming unit for forming an image on the fed sheet 3; and a fixing unit 19. Note that in the printer 1, the side on which the multi-purpose tray 14 is mounted in the main body case 2 (the left side in FIG. 2) is hereinafter referred to as the “front part,” while the side opposite on which the multi-purpose tray 14 is mounted in the main body case 2 is referred to as the “rear part.”

[Description of the Configuration of the Feeder Part 4]

As shown in FIG. 2, in the bottom part of the main body case 2, the feeder part 4 includes a detachable sheet feed tray 6, a sheet retainer plate 8 provided in the sheet feed tray 6, a feed roller 12 provided above an end of the sheet feed tray 6, and a separation pad 13. In addition, there is provided a curved feed path 7 from the feed roller 12 to an image forming position P (or a contact part between a photosensitive drum 23 and a transfer roller 25, i.e., a transfer position at which a toner image on the photosensitive drum 23 is transferred onto the sheet 3).

The sheet retainer plate 8, which can retain the sheets 3 stacked in layers, is pivotably supported at the distal end part relative to the feed roller 12, thereby the proximal end part is allowed to move up and down. The sheet retainer plate 8 is upwardly energized by a spring 8a on its back. The separation pad 13 is disposed to oppose the feed roller 12, so that a pad 13a composed of a member having a high friction coefficient is pushed against the feed roller 12 by a spring 13b.

On the other hand, the feed path 7 is formed in a curved shape by a pair of guide plates 7a and 7b for guiding the sheet 3. In addition, there are disposed at appropriate intervals on the feed path 7 sequentially from the upstream of the sheet feed direction, the feed roller 12; a pair of feed rollers 11 including a pair of a drive roller and a follower roller; a pair of feed rollers 10 including a pair of a drive roller and a follower roller; and a pair of registration rollers 9 including a pair of a drive roller and a follower roller disposed immediately before the image forming position P.

In the feeder part 4 configured as described above, the topmost sheet 3 of those stacked in layers on the sheet retainer plate 8 is pushed against the feed roller 12, and sandwiched between the feed roller 12 and the separation pad 13 by the feed roller 12 being rotated, thereby sheets are fed one by one. The thus fed sheet 3 is also fed by the feed rollers 11, and then sequentially by the feed rollers 10 and the registration rollers 9 to the image forming position P with a predetermined timing.

[Description of the Configuration of the Multi-Purpose Tray 14]

On the front part side of the main body case 2 above the feeder part 4, there are disposed the multi-purpose tray 14 which serves to supply the sheets 3 manually or automatically and a multi-purpose side sheet feed mechanism 15 for feeding the sheets 3 stacked in layers on the multi-purpose tray 14. The multi-purpose side sheet feed mechanism 15 includes a feed roller for the multi-purpose tray 15a and a multi-purpose side sheet feed pad 15b, and allows the multi-purpose side sheet feed pad 15b to be pushed against the feed roller for the multi-purpose tray 15a by a spring 15c disposed on the back of the multi-purpose side sheet feed pad 15b. In addition, the multi-purpose side sheet feed mechanism 15 includes a pair of feed rollers 15d including a pair of drive roller and a follower roller.

In the multi-purpose tray 14 configured as described above, the sheets 3 stacked in layers on the multi-purpose tray 14 are sandwiched between the feed roller for the multi-purpose tray 15a being rotated and the multi-purpose side sheet feed pad 15b, and then fed one by one to the registration rollers 9 via a pair of feed rollers 15d.

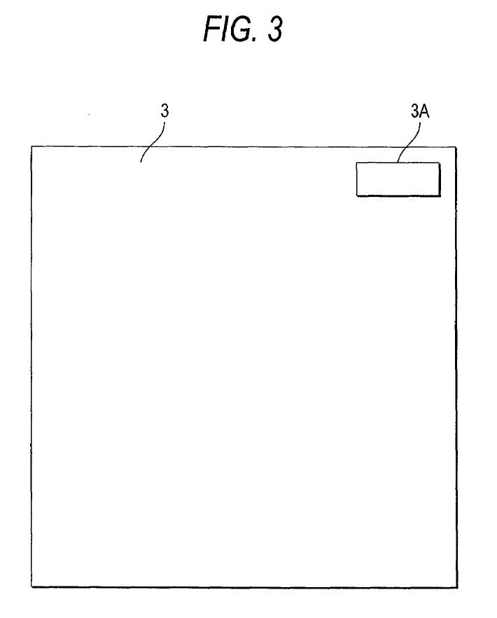

There is also disposed a tag reader 16 serving as data reading unit between the feed rollers 15d, 10 and the registration rollers 9. When the sheet 3 as shown in FIG. 3 having a Radio Frequency Identification Tag (RFID tag: hereinafter simply referred to as the tag) 3A as an example of a non-contact tag is used, the tag reader 16 reads data recorded on the tag 3A. Consequently, while the sheet 3 equipped with the tag 3A is transported from the sheet feed tray 6 or the multi-purpose tray 14 to the image forming position P, the tag reader 16 can read data from the tag 3A attached to the sheet 3. Note that when data is read from (read out from) the tag 3A attached to the sheet 3 held in the multi-purpose tray 14, it is not always necessary to read (read out) the data while the sheet 3 is being fed. For example, with the sheet 3 being held (placed) in the multi-purpose tray 14, the data may be read (read out) from the tag 3A attached to the sheet 3.

[Description of the Configuration of a Scanner Unit 17]

The scanner unit 17 is disposed under a sheet discharging tray 36 in the upper part of the main body case 2, and includes a laser emitting part (not shown), a rotatably driven polygon mirror 20, lenses 21a and 21b, and a reflection mirror 22. The laser emitting part emits a laser beam and the laser beam is passing through or reflected from the polygon mirror 20, the lens 21a, the reflection mirror 22, and the lens 21b so that the scanner unit 17 allows a laser beam to illuminate and quickly scan across the surface of the photosensitive drum 23 of the process unit 18.

[Description of the Configuration of the Process Unit 18]

The process unit 18 includes the photosensitive drum 23 serving as an electrostatic latent image carrier, a scorotron type electrifier 37, a drum cartridge having the transfer roller 25 or the like, and a developing cartridge 24 detachably attached to the drum cartridge. The developing cartridge 24 includes a toner accommodating part 26, a developing roller 27, a layer thickness restricting blade 28, and a toner supply roller 29.

The toner accommodating part 26 is filled with positively charged non-magnetic one-composition polymeric toner as a developer. The toner is supplied by the toner supply roller 29 to the developing roller 27, at the time of which the toner is positively charged by friction between the toner supply roller 29 and the developing roller 27. Furthermore, the toner supplied onto the developing roller 27 is carried on the developing roller 27 in a thin layer of a uniform thickness by the layer thickness restricting blade 28 as the developing roller 27 rotates. On the other hand, the rotating photosensitive drum 23 is disposed opposite the developing roller 27, with the drum body being grounded and its surface being formed of a positively charged organic photosensitive material.

The scorotron type electrifier 37 is disposed above the photosensitive drum 23 with a predetermined gap therebetween so as not to be in contact with the photosensitive drum 23. The scorotron type electrifier 37 is a positively charging scorotron type electrifier which generates corona discharge from an electrifying wire such as of tungsten, and is designed to positively electrify the surface of the photosensitive drum 23 uniformly.

Then, as the photosensitive drum 23 rotates, the surface of the photosensitive drum 23 is first uniformly and positively charged by the scorotron type electrifier 37, and thereafter exposed to the laser beam from the scanner unit 17 during a quick scan, thereby an electrostatic latent image is formed based on the image data.

Subsequently, as the developing roller 27 rotates, the positively charged toner carried on the developing roller 27 is brought into contact with the photosensitive drum 23. At this time, the toner is supplied onto the electrostatic latent image formed on the surface of the photosensitive drum 23, i.e., onto the exposed part having a reduced potential due to the exposure to the laser beam on the uniformly and positively charged surface of the photosensitive drum 23. Thus, the toner is selectively carried to visualize the image, thereby a toner image is formed.

The transfer roller 25 is disposed below the photosensitive drum 23 to oppose the photosensitive drum 23, and supported rotatably in the clockwise direction in FIG. 2 in the drum cartridge. The transfer roller 25 is configured such that a metal roller shaft is coated with a roller formed of an ionic conductive rubber material, and receives a transfer bias (forward transfer bias) applied thereto from a transfer bias application power supply during transfer. Consequently, the toner image carried on the surface of the photosensitive drum 23 is transferred onto the sheet 3 at the above-described image forming position P while the sheet 3 is passing through between the photosensitive drum 23 and the transfer roller 25.

[Description of the Configuration of the Fixing Unit 19]

As shown in FIG. 2, the fixing unit 19 is disposed to the right of the process unit 18 downstream of the feed direction, and includes one heating roller 31, a pressure roller 32 disposed to push against the heating roller 31, and a pair of feed rollers 33 provided downstream of them. The heating roller 31, which is formed of a metal such as aluminum and includes a heater such as a halogen lamp for heating, allows the toner transferred to the sheet 3 in the process unit 18 to be thermally fixed while the sheet 3 passes through between the heating roller 31 and the pressure roller 32. Thereafter, the sheet 3 is fed by the feed rollers 33 into the discharging path in the rear side part of the main body case 2, and then further fed by feed rollers 34 and discharge rollers 35. Subsequently, the sheet 3 is discharged onto the sheet discharging tray 36.

Furthermore, there is provided a tag writer 38, as an example of data recording unit capable of recording data (file) on the above-described tag 3A, on the sheet feed path between the heating roller 31, the pressure roller 32, and the feed rollers 33. Consequently, when the sheet 3 equipped with the tag 3A is used, desired data can be recorded on the tag 3A of the sheet 3 after an image has been formed thereon.

[Description of the Control System of the Printer 1]

In addition, on the upper surface of the printer 1, there are provided various types of buttons (not shown) such as a tag reading button 220A or an operation panel 220 (see FIG. 1) with a liquid crystal display. Referring back to FIG. 1, the operation panel 220 is connected to a controller 200 in conjunction with the process unit 18, the scanner unit 17, the tag writer 38, and the tag reader 16. The controller 200 is configured as a microcomputer including a CPU 201, a ROM 202, a RAM 203, and a NVRAM 204 in which stored contents will not be erased even when the power supply switch is turned OFF. In addition, the controller 200 is connected to the PC 800 via a printer port interface (printer port I/F) 230 and a cable 700.

A PC main body 810 of the PC 800 includes a CPU 811, a ROM 812, a RAM 813, and a hard disc drive (HDD) 814. Here, the RAM 813 includes a tag write data area 813A and a print data area 813B, to be discussed later. Additionally, the PC main body 810 is connected to a display 820 such as a CRT, a keyboard 830, a mouse 840, a printer port interface (printer port I/F) 850 for connecting to a controller 200 of a printer 1, and the like.

[Processing at the Control System (Processing at the PC 800)]

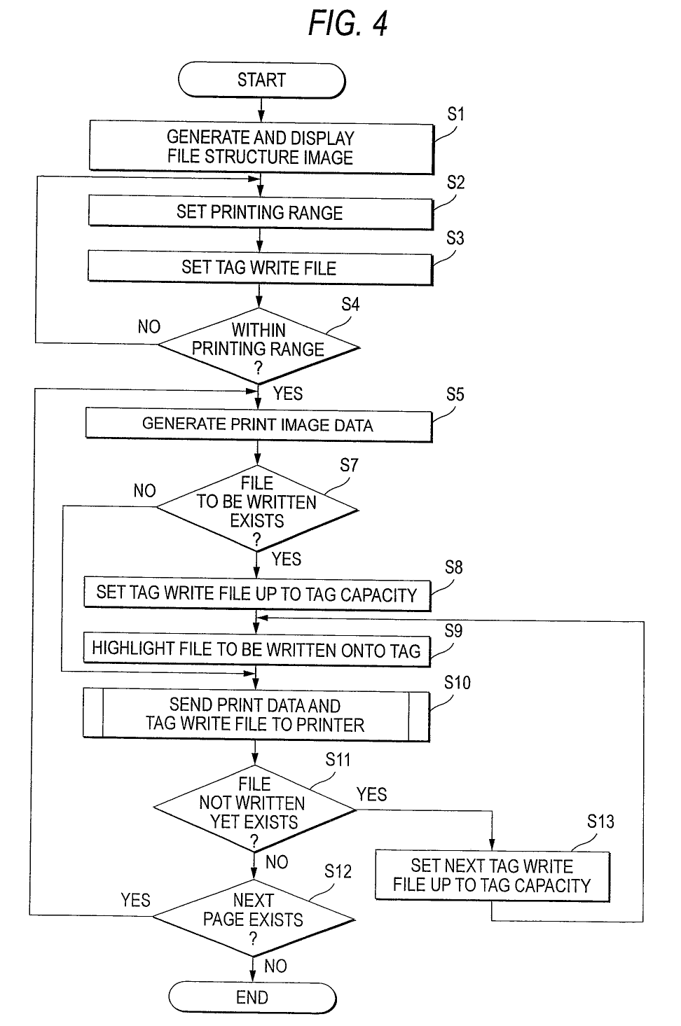

Now, description will be made for the processing at this control system. FIG. 4 is a flowchart showing a printing control process to be executed at the PC 800. Note that this processing is initiated by the CPU 811 executing a predetermined program stored in the HDD 814 when an instruction to perform this processing is issued on the PC 800.

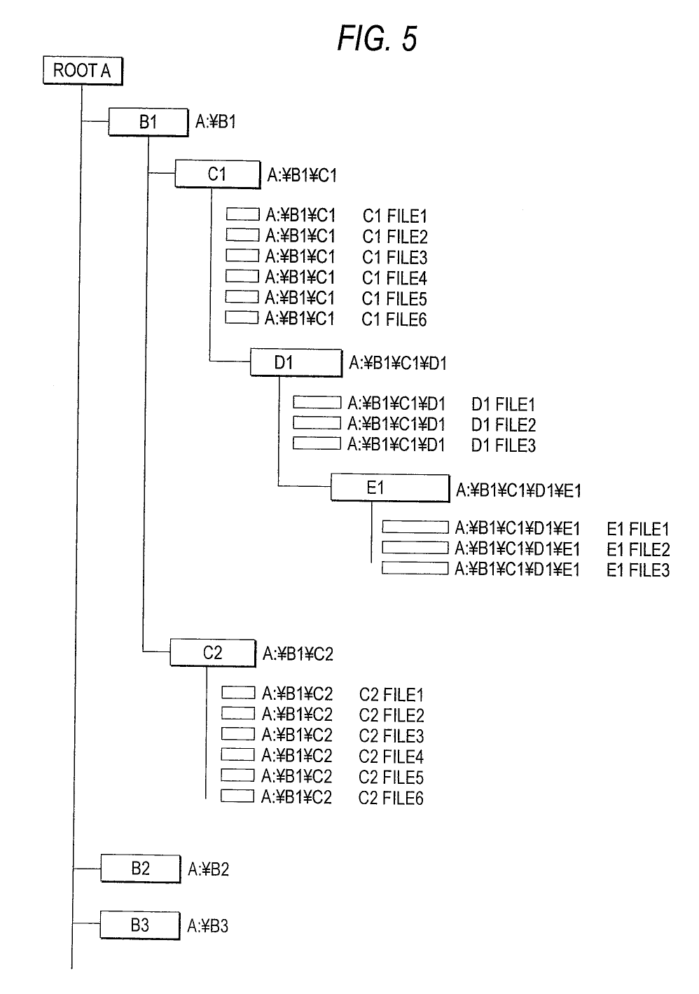

As shown in FIG. 4, when the process is started, first in S1 (hereinafter S stands for a step), an image of a file structure at a particular location within the HDD 814 is generated and then displayed on the display 820. For example, as illustrated in FIG. 5, the diagram of a tree structure (branched hierarchical structure) showing from Root to the end files (an exemplary file structure) is displayed on the display 820. In S2, based on a user's operation with the mouse 840 or the like on the file structure displayed in S1, the printing range of the file structure is set. Note that this printing range may be set to cover the entire range starting from Root or the entire range starting from the desired folder, or may be set on the file structure image.

In S3, based on a user's operation with the mouse 840 or the like on the file structure displayed in S1, the tag write file which should be written into a tag 3A is set from among files displayed on the file structure. Note that like the setting of the printing range (S2), this tag write file may also be set to cover the entire range starting from Root or the entire range starting from a desired folder, or may be set file by file.

After the tag write file is set in S3 in this manner, then in S4, it is determined whether all the tag write file set at S3 is within the printing range set in S2. When all the tag write file is not within the printing range (S4: N), then the process proceeds to S2 mentioned above, and the setting of the printing range (S2) and the setting of the tag write file (S3) are repeated. On the other hand, when all the tag write file is within the printing range (S4: Y), then the process proceeds to S5.

In S5, print image data (hereinafter simply referred to also as print data) corresponding to the printing range set in S2 is generated and then written into the print data area 813B. Note that print data may extend a plurality of pages. In this case, print data is generated page by page here in S5. In S7, it is determined whether a file to be written as the tag write file exists within the printing range corresponding to one page of the generated print data. If a tag write file to be written exists within the printing range (S7: Y), then in S8, the tag write file within the printing range corresponding to the one page of the print data is set up to the storage capacity of the tag 3A on a file by file basis and then written into the tag write data area 813A. Note that the storage capacity of the tag 3A may be acquired via the tag reader 16 by feeding a sheet 3 immediately before a register roller 9. Alternatively, when the storage capacity of the tag 3A is standardized with a specified value which is stored in a predetermined area such as in the HDD 814, the capacity may also be acquired by reading that value.

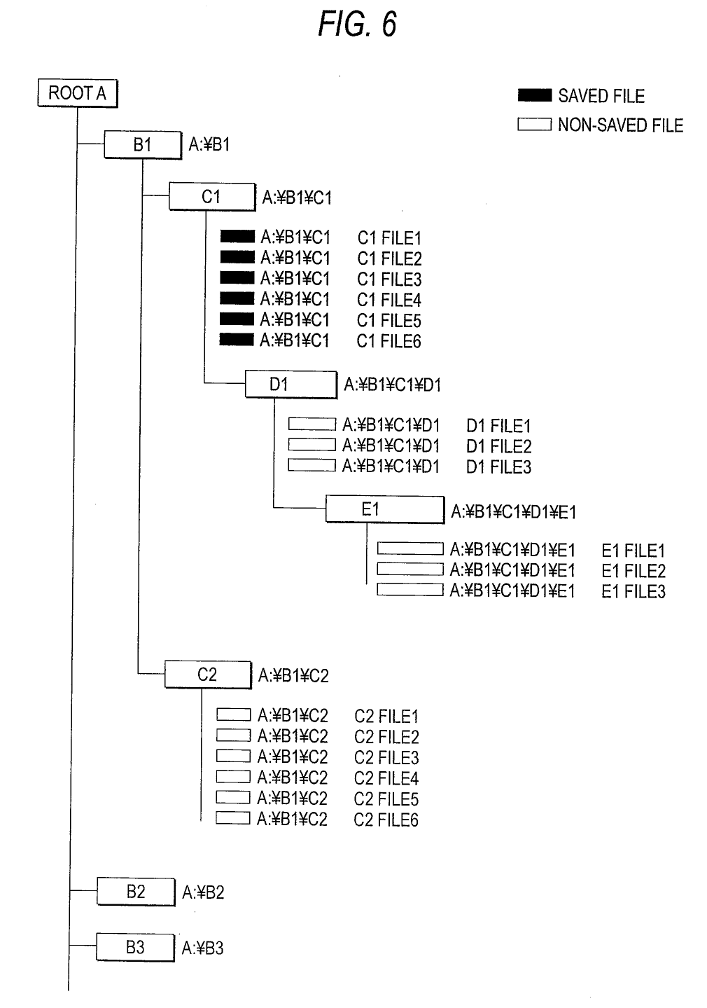

In S9, in the print image data, the file to be written into the tag is highlighted, and accordingly, the data in the print data area 813B is updated. For example, as illustrated by way of example in FIG. 6, the rectangular box representing a file is filled with a predetermined color. Note that various other optional methods can be chosen for the highlighting, e.g., attaching a star mark to the right end of the file name in FIG. 5.

In S10, the tag write file written on the tag write data area 813A and the print data written in the print data area 813B is sent to the printer 1, and then the process proceeds to S11. On the other hand, when a file to be written as the tag write file does not exist within the printing range corresponding to the one page of the print data (S7: N), then the process proceeds directly from S7 to S10, where only the print data of that page is sent.

In S11, it is determined whether or not the file not written yet exists within the same page which could not be written in S8 on the tag 3A due to the lack of its storage capacity. When a file not written yet does not exit (S11: N), then in S12, it is determined whether print data of the next page exists. If no print data of the next page exists (S12: N), then the process ends. On the other hand, when print data of the next page exists (S12: Y), then the process proceeds to S5 to generate the print image data of the next page.

On the other hand, when a file not written yet exists within the same page (S11: Y), then the process proceeds to S13, where as in S8, the remaining tag write file corresponding to that page is set up to the storage capacity of the tag 3A on file by file basis and written into the tag write data area 813A. The process then proceeds to S9 mentioned above. In this case, in S9, the file highlight provided previously through the process of S9 is canceled and the file newly written in the tag write data area 813A is highlighted. Then, after all the tag write file is completely written in the tag write data area 813A (S8 and S13) and the tag write file is completely sent (S10) (S11: Y), and then the process proceeds to S12 mentioned above.

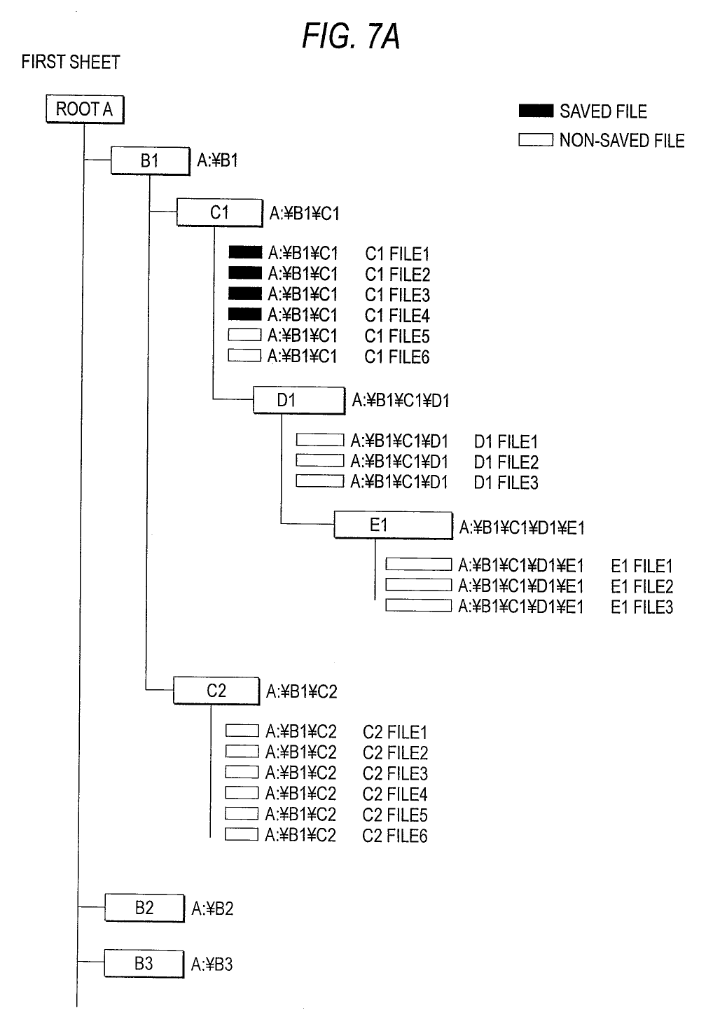

Through the above processes, for example, in S10, the following print data is sent depending on the tag write file within the printing range corresponding to the print data of that page and the storage capacity of the tag 3A. That is, when all of the tag write file can be written in one tag 3A (S11: N), then as illustrated by way of example in FIG. 6, a page of print data is sent (S10) with the file written in the tag 3A as the tag write file being highlighted (see S9). On the other hand, if all of the tag write file cannot be written in one tag 3A (S11: Y), then as illustrated by way of example in FIG. 7, a plurality of pages of print data are sent (S10) with only the file written in the tag 3A attached to the sheet 3 being highlighted (see S9).

Consider the example of FIG. 7 where all the files contained in a folder C1 or “A:¥B1¥C1” are set as the tag write file. This example shows that a C1 file 1 to a C1 file 4 are written on the tag 3A attached to the first sheet 3, while a remaining C1 file 5 and C1 file 6 are written on the tag 3A attached to the second sheet 3.

On the other hand, when the printing range set in S2 is so large that the tree structure image associated with the printing range cannot be printed on one sheet 3 (S12: Y), a plurality of pages of print data is sent as well (S10). In this case, the tree structure image printed on each page is also varied.

[Process in the Control System (Process in the Printer 1)]

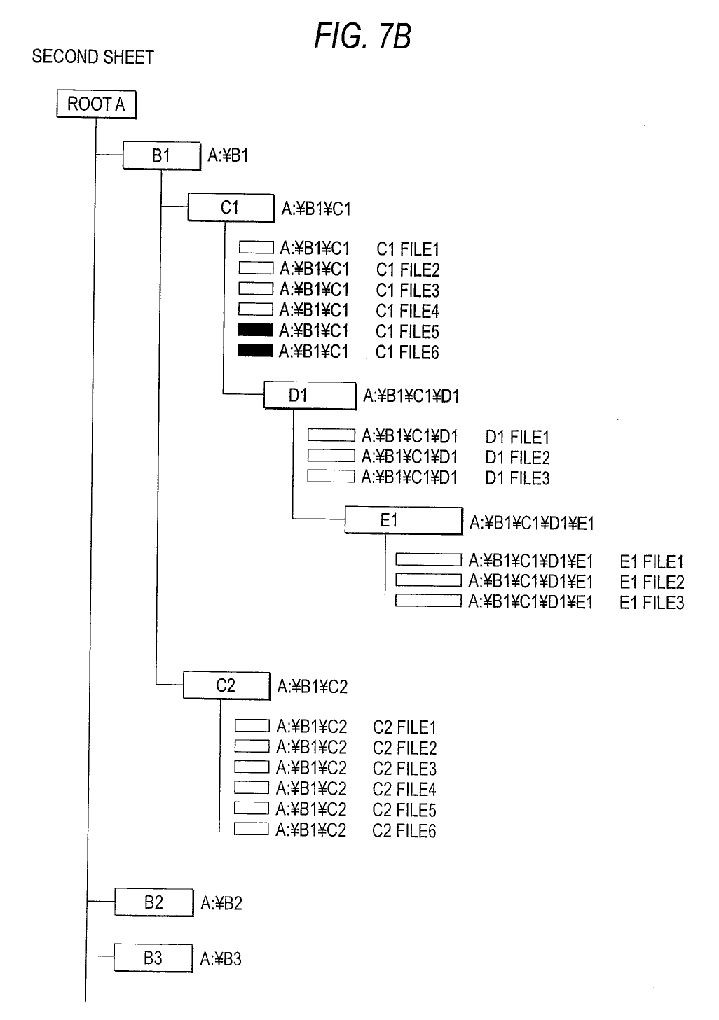

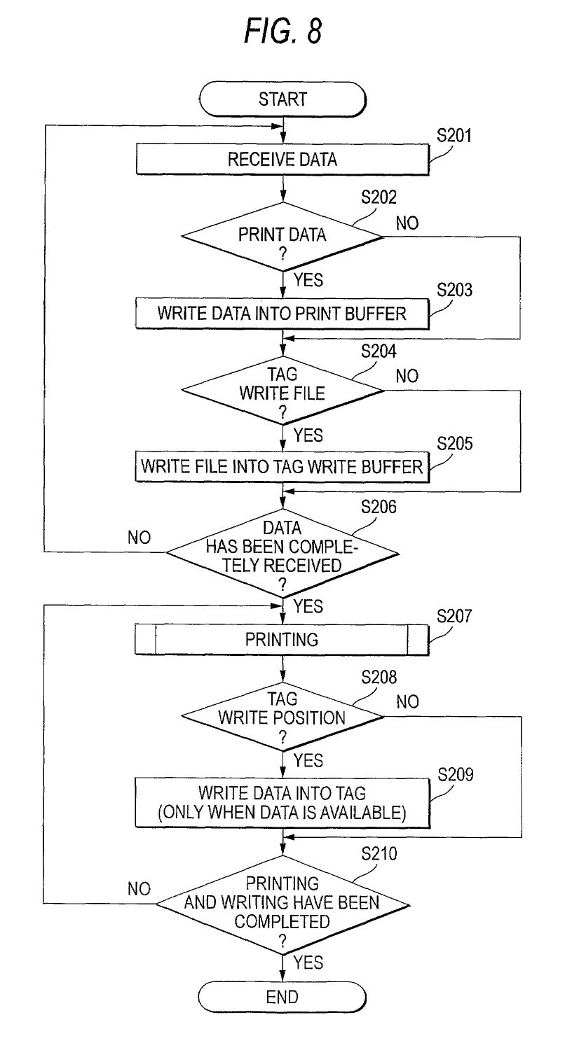

FIG. 8 is a flowchart showing a printer printing process to be executed by the controller 200 of the printer 1 in response to the processing of S10 mentioned above. This process is started when data is sent from the PC 800.

As shown in FIG. 8, when the process is started, the data sent from the PC 800 is first received in S201. In S202, it is determined whether the received data is print data. When it is print data (S202: Y), then in S203, the print data is written into a print buffer set in the RAM 203 and the process proceeds to S204. When it is not print data (S202: N), the process proceeds to S204.

In S204, it is determined whether the received data is a tag write file. When it was tag write file (S204: Y), then in S205, the tag write file is written into a tag write buffer set in the RAM 203. After that, when it was not tag write file (S204: N), the process proceeds to S206. In S206, it is determined whether the data from the PC 800 has been completely received. When the data has not yet completely received (S206: N), the process proceeds to S201, so that the processes of S201 to S205 mentioned above will be repeated.

On the other hand, when the data has already been completely received from the PC 800 (S206: Y), the process proceeds to S207, where printing on the sheet 3 is started by driving the scanner unit 17, the process unit 18 and the like in accordance with the print data. In S208, it is determined whether the sheet 3 has been conveyed to the tag write position at which the tag writer 38 can write data onto the tag 3A. When it is not at the tag write position (S208: N), the process proceeds to S210. When it is at the tag write position (S208: Y), then in S209, the tag write file is written into the tag 3A only when the tag write file is available, and thereafter, the process proceeds to S210.

In S210, it is determined whether printing of data on the sheet 3 and writing of data on the tag 3A has completed appropriately. When not completed yet (S210: N), the process proceeds to S207, so that the processes of S207 to S209 mentioned above will be repeated. When printing onto the sheet 3 and writing onto the tag 3A has completed appropriately (S210: Y), then the process ends. Through the foregoing processes, the image corresponding to the printing range, the tag write file, the storage capacity of the tag 3A and the like as described above is printed on the sheet 3, while the corresponding tag write file is written into the tag 3A.

The controller 200 executes the following tag data read process when it has received from the PC 800 an instruction for reading data on the tag 3A or when a tag read button 220A of the control panel 220 is pressed.

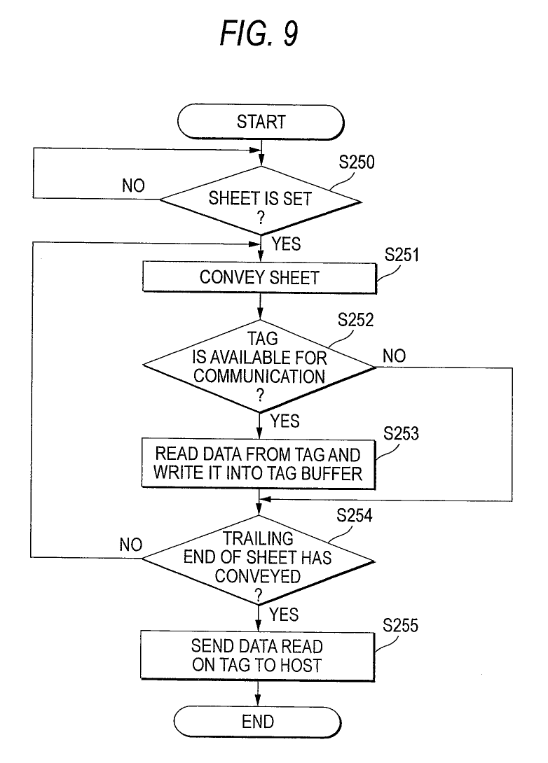

FIG. 9 is a flowchart showing the tag data read process. As shown in FIG. 9, when the process is started, it is first determined in S250 whether the sheet 3 is set in the multi-purpose tray 14. If the sheet 3 is not set (S250: N), the process waits as it is in S250. If the sheet 3 is set (S250: Y), then in S251, the sheet 3 is started to be conveyed.

In S252, it is determined whether the tag reader 16 can communicate with the tag 3A. If they cannot communicate with each other (S252: N), the process proceeds to S254. If they can communicate with each other (S252: Y), then in S253, data is read from the tag 3A via the tag reader 16 and written into the tag buffer in the RAM 203, and then the process proceeds to S254. In S254, it is determined whether the trail end of the sheet 3 has conveyed and the sheet 3 is discharged onto the sheet discharging tray 36. When the trail end of the sheet has not conveyed (S254: N), the process proceeds to S251 mentioned above, where the processes of S251 to S253 will be repeated. When the trail end of the sheet has conveyed (S254: Y), the process proceeds to S255.

In S255, the data read from the tag 3A in S253 is sent to the host (the PC 800 in this case), and the process ends. The data in the tag 3A is sent to the PC 800 in this manner, thereby allowing the file set as the tag write file as described above (see S3) to be read from the tag 3A and utilized by the PC 800. In addition, since such an image as mentioned above is printed on the sheet 3, a desired file can be found very easily to utilize it on the PC 800.

### Effects and Modified Examples of the Present Embodiment

As described above, in this embodiment, the storage location of data (file) at its source to be written on the tag 3A is printed as a tree structure image on the sheet 3 attached with the tag 3A. Furthermore, in the tree structure image, those files written into the tag 3A are highlighted. Accordingly, it is possible to visually readily recognize the storage location of the file at its source written on the tag 3A. Additionally, the relation between the file written into the tag 3A and the file not written thereon (in some cases, data written on the tag 3A attached to another sheet 3) can also be recognized at a glance. Note that the process of S13 may be repeated so that the file to be written into the tag 3A attached to another sheet 3 may be also distinguished from a file which has never been written as tag write file in this printing control process. In this case, the user can determine whether the user should search for another sheet 3 or directly acquire from the PC 800 serving as the source of data in order to acquire desired data.

Additionally, the present invention is not limited by any means to the above embodiment but may also be carried out in various forms without deviating from the scope and spirit of the present invention. For example, images of various forms other than those described above are also conceivable as the image representing the storage location of the tag write file at its source.

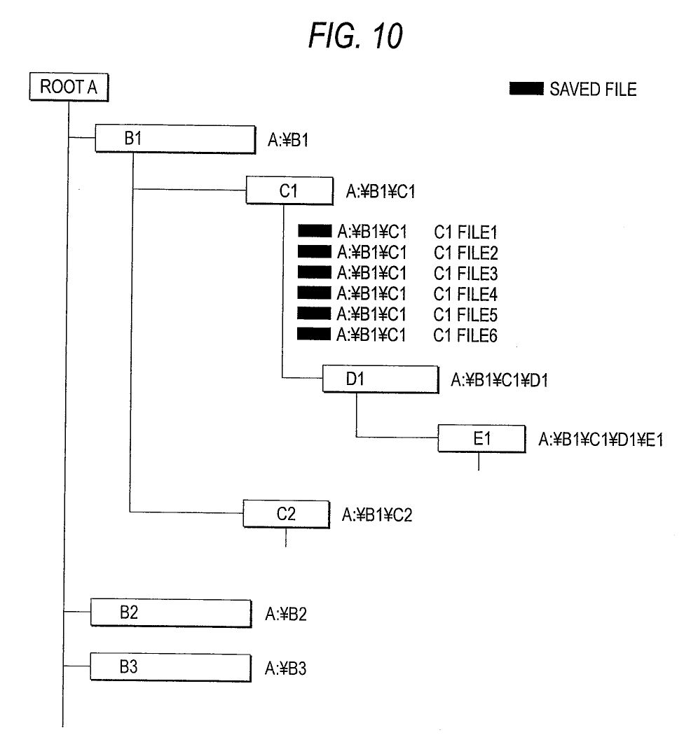

As illustrated by way of example in FIG. 10, only those rectangular boxes representing files and their file names that are written into the tag 3A may be printed. Alternatively, those items may also be printed such as the date of printing, the date and time of the generation of the file, and the date and time of updates.

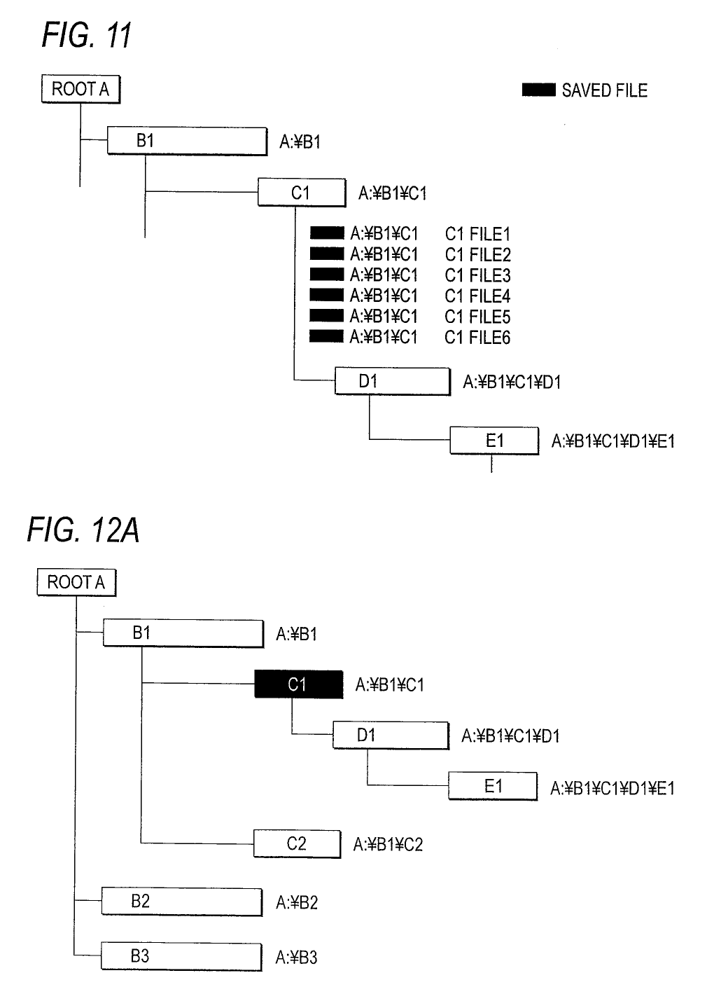

Additionally, as illustrated by way of example in FIG. 11, those files or folders located not at a level higher nor lower than the level of the file that is written into the tag 3A as the tag write file (i.e., files or folders located not in the direct path but in an indirect path) may not be printed.

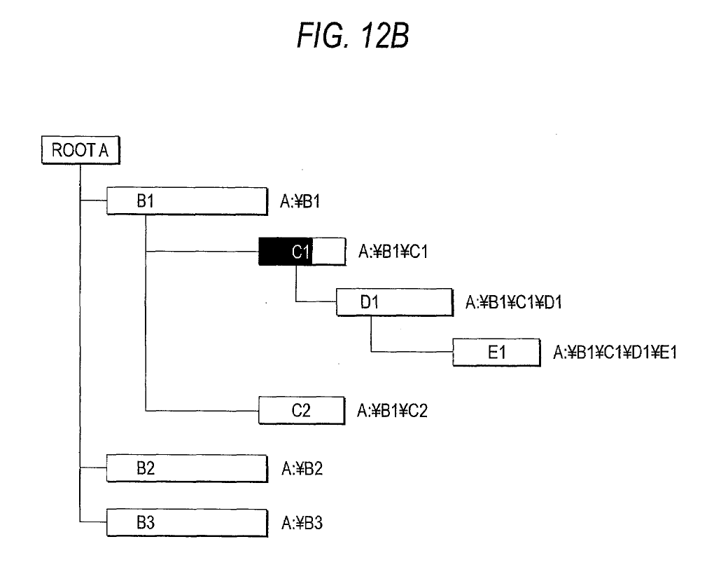

Furthermore, as illustrated by way of example in FIG. 12A, only folders maybe expressed in a tree structure, so that the folder to which the file corresponding to the tag write file belongs is highlighted as described above. That is, the storage location of the file is indicated by an image of the folder in a file structure. In this case, as shown in FIG. 12B, if only some of the files of the folder are written into the tag 3A, the rectangle representing the folder may not be completely filled but, e.g., partially filled. Alternatively, the rectangle may be filled at some ratio, e.g., a half or one third, thereby indicating how much the whole folder is occupied by those files written on the tag 3A.

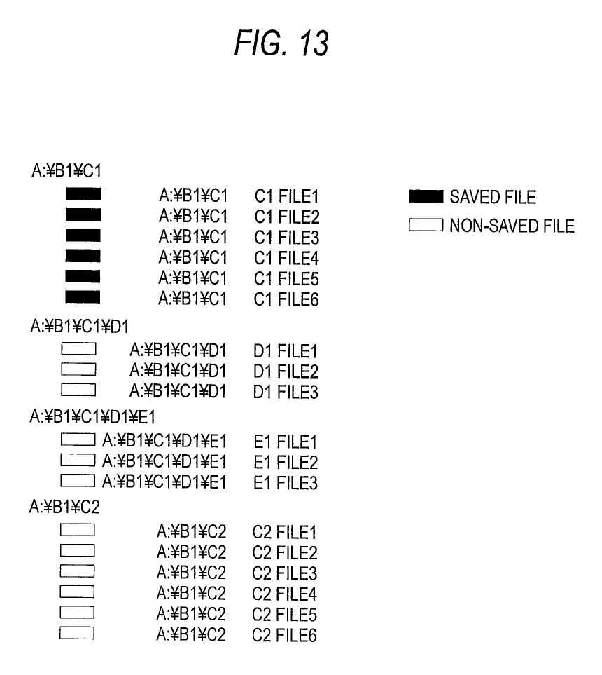

Furthermore, as illustrated by way of example in FIG. 13, not a tree structure but only a rectangular box representing a file and its file name may be used to indicate the storage location. This is advantageous when a number of small files are written on the tag 3A so that the area of the sheet 3 is small compared with the number of files. Furthermore, as illustrated by way of example in FIG. 13, when the file name contains information such as “A:¥B1¥C1” indicating the storage location on the file structure, the storage location of the tag write file at its source on the file structure can be recognized at a glance. Furthermore, in the above embodiment, the tag write file itself may also include location information indicating the storage location where the tag write file is stored on the file structure.

Additionally, when a folder corresponding to image data and another folder are contained as the tag write file, an image corresponding to the image data and an image of the tree structure or the like may be printed on the sheet 3 at the same time. Furthermore, the image forming unit may form images not only by electrophotography as in this embodiment but also by ejecting ink. A tag which transmits and receives data using infrared rays may also be employed as a non-contact tag. Furthermore, when the printer 1 includes a control panel 220 of an appropriate size, all the processes executed by the PC 800 in the above embodiment may be executed by the controller 200. In this case, the single printer 1 can configure the image forming apparatus of the embodiment.

Furthermore, for example, a multi-function device may be equipped with a scanner (original document reader) function, a copying function, or a facsimile function in addition to the printer function. In this case, while the automatic document feeding mechanism (so-called ADF mechanism) included in the scanner function is conveying the sheet 3 equipped with the tag 3A, the tag reader installed along the conveying path may read the data written on the tag 3A.

As described above, since the tag 3A can store files and the sheet indicates the storage location of the files, the sheet 3 equipped with the tag 3A can be used for backing up the files.

The present invention provides illustrative non-limiting embodiments as follows:

An image forming apparatus includes: an image forming unit; a data recording unit that records a file on a non-contact tag attached to a recording medium; and a controller that controls the image forming unit to form, on the recording medium, an image indicating a storage location of the file recorded on the non-contact tag at a source of the file.

According to the above configuration, the data recording unit records a file on the non-contact tag when the non-contact tag is attached to the recording medium. Furthermore, in this case, the controller controls the image forming unit to form an image indicating the storage location of the file at a source of the file on the recording medium equipped with the non-contact tag. Accordingly, the storage location of the file at the source of the file can be recognized at a glance on the image formed on the recording medium.

The storage location of the file may be indicated by a branched hierarchical structure (tree structure). In this case, the storage location of the file at the source of the file can be visually recognized.

The storage location of the file may be indicated by a file name of the file. In this case, the storage locations corresponding to a number of files can be formed as an image on a small space. Accordingly, this provides an advantage when a number of small files are recorded on a non-contact tag attached to a recording medium which has a small area in view of the number of files.

The file name may include location information indicating the storage location of the file in a file structure at the source of the file. In this case, the storage location of the file at the source thereof in the file structure can be recognized at a glance.

The storage location of the file may be indicated by an image of a folder in a file structure at the source of the file. In this case, the storage location of the data at the source of the file in the file structure can be visually recognized at a glance.

The storage location of the file may indicate a relation with a file not recorded on the non-contact tag, and the image may be formed on the recording medium so that the file recorded on the non-contact tag and the file not recorded on the non-contact tag is distinguishable. In this case, the relation between the data recorded on the non-contact tag and the data not recorded thereon (which may also include such data that is recorded on a non-contact tag attached to another recording medium) can also be recognized at a glance.

When a total volume of files to be recorded on the non-contact tag is greater than a capacity of the non-contact tag, the data recording unit divides the files and respectively records the divided files on a plurality of non-contact tags attached to a plurality of recording media. In this case, it may be possible to store a large volume of data without being limited by the capacity of the non-contact tag.

When the data recording unit divides the files to respectively record the divided files on the plurality of non-contact tags attached to the plurality of recording media, the controller may control the image forming unit to form, on each of the recording media, an image indicating storage locations of the divided files recorded on the corresponding non-contact tag. In this case, it can be recognized at a glance which one of the divided files are recorded on which one of the non-contact tags that are respectively attached to the recording media.

The data recording unit may record, on the non-contact tag, the file and data including the storage location of the file at the source of the file. In this case, the storage location of data at its source is also readily recognized from the data recorded on the non-contact tag.

A computer program product embodied on a computer readable medium, which when executed by a computer, causes the computer to perform operations, the computer communicating with an image forming apparatus including an image forming unit and a data recording unit that records a file on a non-contact tag attached to a recording medium, the operations including: controlling the image forming unit of the image forming apparatus to form, on the recording medium, an image indicating a storage location of the file recorded on the non-contact tag at a source of the file.

A method for controlling an image forming apparatus including an image forming unit and a data recording unit that records a file on a non-contact tag attached to a recording medium, includes: controlling the image forming unit of the image forming apparatus to form, on the recording medium, an image indicating a storage location of the file recorded on the non-contact tag at a source of the file.

A system includes a computer and an image forming apparatus. The computer includes: a print data generating unit that generates a print data of an image indicating a storage location of a file at a source of the file; and a communicating unit that transmits the print data generated by the print data and the file. The image forming apparatus includes: a communicating unit that receives the print data and the file transmitted from the communicating unit of the computer; an image forming unit that forms the image based on the print data on a recording medium; and a data recording unit that records the file on a non-contact tag attached the recording medium.

The computer may further include a file designating unit that designates a file to be recorded on the non-contact tag.

What is claimed is:

1. An image forming apparatus comprising:
an image forming unit;
a data recording unit that records a file on a non-contact tag attached to a recording medium; and
a controller that controls the image forming unit to form, on the recording medium, an image indicating a storage location of the file recorded on the non-contact tag at a source of the file.

2. The image forming apparatus according to claim 1, wherein the storage location of the file is indicated by a branched hierarchical structure.

3. The image forming apparatus according to claim 1, wherein the storage location of the file is indicated by a file name of the file.

4. The image forming apparatus according to claim 3, wherein the file name includes location information indicating the storage location of the file in a file structure at the source of the file.

5. The image forming apparatus according to claim 1, wherein the storage location of the file is indicated by an image of a folder in a file structure at the source of the file.

6. The image forming apparatus according to claim 1,
wherein the storage location of the file indicates a relation with a file not recorded on the non-contact tag, and
wherein the image is formed on the recording medium so that the file recorded on the non-contact tag and the file not recorded on the non-contact tag is distinguishable.

7. The image forming apparatus according to claim 1,
wherein when a total volume of files to be recorded on the non-contact tag is greater than a capacity of the non-contact tag, the data recording unit divides the files and respectively records the divided files on a plurality of non-contact tags attached to a plurality of recording media.

8. The image forming apparatus according to claim 7,
wherein when the data recording unit divides the files to respectively record the divided files on the plurality of non-contact tags attached to the plurality of recording media, the controller controls the image forming unit to form, on each of the recording media, an image indicating storage locations of the divided files recorded on the corresponding non-contact tag.

9. The image forming apparatus according to claim 1,
wherein the data recording unit records, on the non-contact tag, the file and data including the storage location of the file at the source of the file.

10. A computer program product embodied on a computer readable medium, which when executed by a computer, causes the computer to perform operations, the computer communicating with an image forming apparatus comprising an image forming unit and a data recording unit that records a file on a non-contact tag attached to a recording medium, the operations comprising:
controlling the image forming unit of the image forming apparatus to form, on the recording medium, an image indicating a storage location of the file recorded on the non-contact tag at a source of the file.

11. A system comprising:
a computer comprising:
a print data generating unit that generates a print data of an image indicating a storage location of a file at a source of the file; and
a communicating unit that transmits the print data generated by the print data and the file; and
an image forming apparatus comprising:
a communicating unit that receives the print data and the file transmitted from the communicating unit of the computer;
an image forming unit that forms the image based on the print data on a recording medium; and
a data recording unit that records the file on a non-contact tag attached the recording medium.

12. The system according to claim 11,
wherein the computer further comprises a file designating unit that designates a file to be recorded on the non-contact tag.
